(19) United States
(12) Patent Application Publication
(10) Pub. No.: US 2015/0023572 A1
(43) Pub. Date: Jan. 22, 2015

(54) SYSTEM AND METHODS FOR PROVIDING FINGER VEIN AUTHENTICATION AND SIGNATURE FOR EXECUTION OF ELECTRONIC WALLET TRANSACTIONS

(71) Applicant: Rocky Williform, Atlanta, GA (US)

(72) Inventor: Rocky Williform, Atlanta, GA (US)

(21) Appl. No.: 14/336,798

(22) Filed: Jul. 21, 2014

Related U.S. Application Data
(60) Provisional application No. 61/856,790, filed on Jul. 22, 2013.

(51) Int. Cl. G06K 9/00; G06Q 20/36; G06Q 20/40

(52) U.S. Cl. CPC G06K 9/00033; G06K 9/00087; G06Q 20/40145; G06Q 20/36
USPC 382/124

(57) ABSTRACT

The present invention generally relates to systems and methods for authenticating and signing electronic wallet transactions. Specifically, this invention relates to systems and methods for providing authentication of electronic wallet transactions via finger vein detection and analysis means. Embodiments of the present invention utilize finger vein detection means to allow contactless authentication of users for electronic transactions, generally via an electronic wallet. Further, embodiments of the present invention may allow for contactless signature methods for completion of such electronic transactions.

### CROSS REFERENCE TO RELATED APPLICATIONS

This application claims the benefit of U.S. Provisional Patent Application No. 61/856,790 filed Jul. 22, 2013 and entitled “System and Methods for Providing Finger Vein Authentication and Signature For Execution of Electronic Wallet Transactions” the entire disclosure of which is incorporated herein by reference.

### FIELD OF THE INVENTION

The present invention generally relates to systems and methods for authenticating and signing electronic wallet transactions. Specifically, this invention relates to systems and methods for providing authentication of electronic wallet transactions via finger vein detection and analysis means. Embodiments of the present invention utilize finger vein detection means to allow contactless authentication of users for electronic transactions, generally via an electronic wallet. Further, embodiments of the present invention may allow for contactless signature methods for completion of such electronic transactions.

### BACKGROUND OF THE INVENTION

Currently, there are number of methods that exist for verifying, authenticating, authorizing, or otherwise providing a signature for an electronic and other transactions, including username and passwords, personal identification numbers (PIN), and identification cards. Recently, biometric authentication has become increasingly popular, with finger print matching and other similar biometric parameters being used to provide unique authentication credentials to a user of a given system. One biometric parameter that has not been fully utilized is the vein patterns in a person's finger. For example, it is possible to scan and analyze the vein pattern in on or more of a person's fingers in order to provide biometric identification. Furthermore, currently available authentication and signature methods require that a person touch or otherwise physically interact with an authentication means in order to verify the person's identity, which creates a number of hygienic and cleanliness concerns.

Therefore, there is a need in the art for an authentication method that can scan and identify biometric parameters of a person without requiring the person to make physical contact with an authentication means. These and other features and advantages of the present invention will be explained and will become obvious to one skilled in the art through the summary of the invention that follows.

### SUMMARY OF THE INVENTION

Accordingly, it is an object of the present invention to provide a system and method for the scanning and analyzing of a finger veins as means for authorizing and providing a signature for electronic wallet transactions and other transaction where identity verification is required.

According to an embodiment of the present invention, a system for providing access to and authorization of electronic wallet transactions using finger vein analysis, the system comprising: a vein analysis module, comprising computer-executable code stored in non-volatile memory, a wallet module, comprising computer-executable code stored in non-volatile memory, a processor, and a vein detection means, wherein the vein analysis module, the wallet module, the processor, and the vein detection means are operably connected and are configured to: receive a transaction request, initiate a transaction, wherein the transaction is analyzed to determine a transaction type, retrieve transaction information, wherein the transaction information is comprised of one or more of a transaction purpose, a transaction location, and system information, request finger vein authentication from user, wherein the finger vein detection means scans one or more of fingers of the user to generate a first finger vein pattern, process the first finger vein pattern, wherein the first finger vein pattern is analyzed to authenticate identity of the user, verify the identity of the user by comparing the first finger vein pattern to a reference finger vein pattern, and provide access to one or more credentials stored in an electronic wallet.

According to an embodiment of the present invention, the vein analysis module, the wallet module, the processor, and the vein detection means are operably connected and are further configured to select one of the one or more credentials stored in the electronic wallet based on the transaction type.

According to an embodiment of the present invention, the vein analysis module, the wallet module, the processor, and the vein detection means are operably connected and are further configured to: request a finger vein signature from the user, wherein the finger vein signature is collected with the finger vein detection means and comprised of a signature stroke pattern and a second finger vein pattern, receive the finger vein signature from the user, analyze the finger vein signature, wherein the signature stroke pattern is authenticated and the second finger vein pattern is compared to the first finger pattern, verify that the second finger vein pattern matches the first finger vein pattern used to access the digital wallet, and authorize a transaction to be completed from the digital wallet.

According to an embodiment of the present invention, the vein analysis module, the wallet module, the processor, and the vein detection means are operably connected and are further configured to store a transaction authorization comprised of an analysis of the finger vein signature.

According to an embodiment of the present invention, the finger vein detection means is configured to scan the one or more of fingers of the user without directly contacting the user.

According to an embodiment of the present invention, the system is further comprised of one or more communication means operably connected to the vein analysis module, the wallet module, the processor, and the vein detection means.

According to an embodiment of the present invention, the finger vein data pattern is analyzed remotely using one or more remote computing devices communicatively linked to the finger vein analysis module.

According to an embodiment of the present invention, the finger vein data pattern is analyzed locally with the finger vein analysis module.

According to an embodiment of the present invention, the one or more credentials are selected from a group of credentials comprising financial credentials, travel credentials, medical credentials, identification credentials, and insurance credential.

According to an embodiment of the present invention, a method for providing access to and authorization of electronic wallet transactions using finger vein analysis, the method comprising the steps of: receiving a transaction request, initiating a transaction, wherein the transaction is analyzed to determine a transaction type, retrieving transaction information, wherein the transaction information is comprised of one or more of a transaction purpose, a transaction location, and system information, requesting finger vein authentication from user, wherein one or more of fingers of the user are scanned to generate a first finger vein pattern, processing the first finger vein pattern, wherein the first finger vein pattern is analyzed to authenticate identity of the user, verifying the identity of the user by comparing the first finger vein pattern to a reference finger vein pattern, and providing access to one or more credentials stored in an electronic wallet.

According to an embodiment of the present invention, the method further comprises the step of selecting one of the one or more credentials stored in the electronic wallet based on the transaction type.

According to an embodiment of the present invention, the method further comprises the steps of: requesting a finger vein signature from the user, wherein the finger vein signature is collected with the finger vein detection means and comprised of a signature stroke pattern and a second finger vein pattern, receiving the finger vein signature from the user, analyzing the finger vein signature, wherein the signature stroke pattern is authenticated and the second finger vein pattern is compared to the first finger pattern, verifying that the second finger vein pattern matches the first finger vein pattern used to access the digital wallet, and authorizing a transaction to be completed from the digital wallet.

According to an embodiment of the present invention, the method further comprises the step of storing a transaction authorization comprised of an analysis of the finger vein signature.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a schematic overview of an exemplary system, in accordance with an embodiment of the present invention;

FIG. 3 illustrates a network schematic of a system, in accordance with an embodiment of the present invention;

FIG. 4 illustrates a network schematic of a system, in accordance with an embodiment of the present invention; and

FIG. 5 is a process flow for an exemplary finger vein authentication and signature method, in accordance with an embodiment of the present invention.

### DETAILED SPECIFICATION

The present invention generally relates to systems and methods for authenticating and signing electronic wallet transactions. Specifically, this invention relates to systems and methods for providing authentication of electronic wallet transactions via finger vein detection and analysis means. Embodiments of the present invention utilize finger vein detection means to allow contactless authentication of users for electronic transactions, generally via an electronic wallet. Further, embodiments of the present invention may allow for contactless signature methods for completion of such electronic transactions.

According to a preferred embodiment of the present invention, the purpose of the system and methods described herein are to allow the use of a unique finger signature to control access and authorization of a mobile smart wallet (AKA electronic wallet) credentials to conduct mobile transactions (e.g., payments, identification confirmation, age verification, insurance verification). Transactions include all types of transactions, including, but not limited to, consumer to consumer, consumer to business, business to business, peer to peer, or any combination thereof. One of ordinary skill in the art would appreciate that there are numerous types of transactions that could be conducted via the system and methods described herein and embodiments of the present invention are contemplated for use with any type of transaction.

According to an embodiment of the present invention, the finger signature utilized in these preferred embodiments of the present invention are of one or more unique vein patterns of one or more designated fingers of a user, which is/are swiped in mid-air at POS terminal, or other computing means appropriately equipped, to access the credentials. In certain embodiments, the system may further be configured to allow a signature to be stroked in mid-air via a designated finger or fingers or other means to authorize a transaction. In preferred embodiments, both authentication and signature are contactless and are detected by infrared or other appropriate means, so there is no requirement to touch or make contact with physical medium at a POS terminal or other appropriately equipped computing device.

However, while this application focuses on systems for providing contactless finger vein pattern authentication and finger vein pattern signature methods, other embodiments of the present invention may be utilized with systems for providing finger vein pattern authentication and finger vein pattern signature methods that utilize contact based components. One of ordinary skill in the art would appreciate that such systems and methods would not deviate from the scope of the invention. For instance, in certain embodiments, the finger vein detection means, described below, could utilize a finger vein detection means that would require or allow for contact of one or more fingers with the finger vein detection means during the detection process, for authentication, signature or any combination thereof.

According to an embodiment of the present invention, the system provides an enhanced way for transactions to be conducted and to make it more seamless, secure and speedy. The authentication means described herein cannot be replicated or copied and provides a secure alternative to the current authentication methods at POS terminals of “What You Have” (e.g., physical medium such as credit and debit cards and consumer/user devices) or “What You Know” (e.g., username and password).

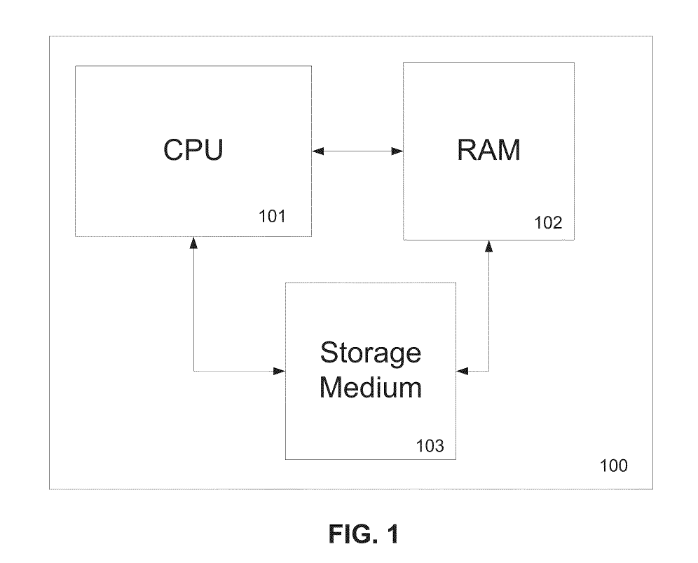

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, point-of-sale (POS) systems, retail registers, personal computers, smart phones, laptops, mobile computing devices, tablet PCs and servers. In certain embodiments of the present invention, aspects of the invention may require specialized hardware to be connected to such computing devices to enable full functionality, such as a finger vein detection means. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks, wireless networks, near field communications) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

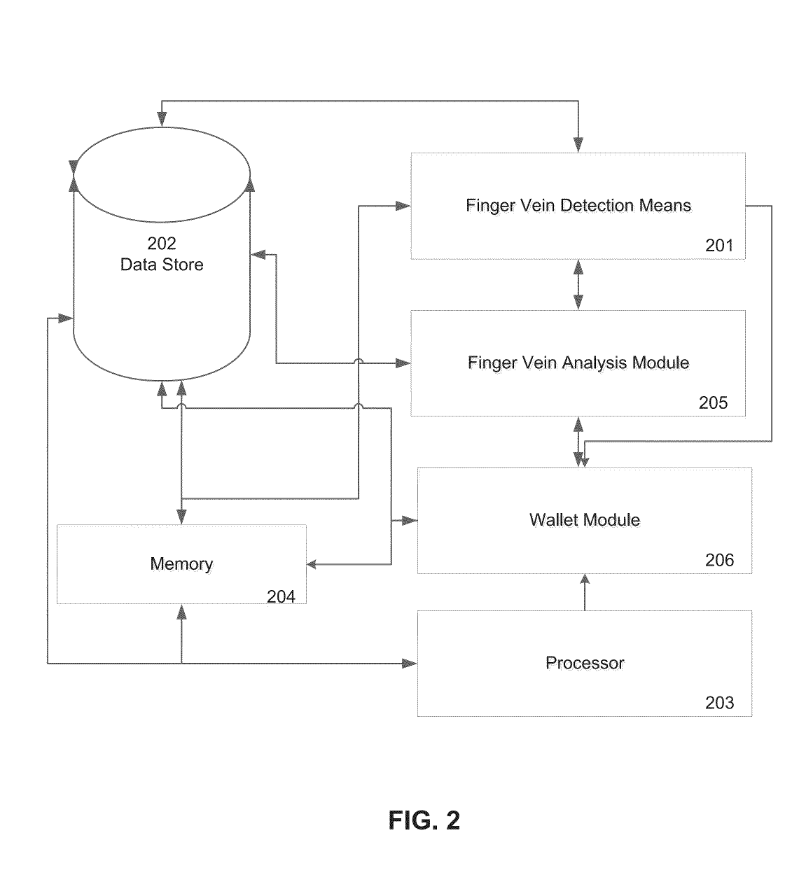

Turning to FIG. 2, according to an embodiment of the present invention, a system for providing finger vein authentication for execution of electronic wallet transactions is comprised of one or more finger vein detection means 201, one or more data stores 202, a processor 203, memory 204, a finger vein analysis module 205 and a wallet module 206. In alternate embodiments, the system may have additional or fewer components. For instance, the system may be further comprised of one or more communications means configured to allow for transmission and receipt of data from one or more remote computing devices (e.g., application server, database server). One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the finger vein detection means is configured to read, scan or otherwise identify one or more unique vein patterns of a designated finger of a user. In preferred embodiments, the finger vein detection means is configured to allow for mid-air identification of the one or more unique finger vein patterns contained in the user's finger(s). Advantageously, the no-touch system provides a biometric improvement over standard fingerprint methods in both security and cleanliness as unique vein patterns are difficult if not impossible to replicate and the no-touch design prevents or limits transmission of communicable bacteria and diseases.

In certain embodiments, the finger vein detection means may be further configured to receive the signature of a user via a no-touch means. In a preferred embodiment of the present invention, the finger vein detection means may be configured to allow a user to sign a transaction receipt, or other document requiring a signature, with the same no-touch benefits as found in the no-touch finger vein authentication. In practice, the user will simply swipe or otherwise move their finger, fingers or hand in a motion that ultimately is read as their signature (e.g., as if a pen or other writing utensil was present in the user's hand).

According to an embodiment of the present invention, the finger vein analysis module is configured to receive the finger vein information from the finger vein detection means and process the finger vein information to confirm the identity of a user. Processing may take place locally at the finger vein analysis module or remotely at one or more remote computing devices communicatively connected to the finger vein analysis module. Where processing takes place remotely, the finger vein analysis module may communicate the data through the one or more communication means of the system.

In certain embodiments, the finger vein analysis module may further be configured to analyze the signature of the user as well. Similar to the finger vein analysis, once the signature data is received, the finger vein analysis module may be configured to analyze the signature locally or remotely in conjunction with one or more remote computing devices.

According to an embodiment of the present invention, the wallet module is configured to retrieve, store, access, modify or otherwise interact with one or more credentials stored electronically and associated with a user. Credentials include, but are not limited to, financial credentials (e.g., credit, debit, EBT, banking, ACH, wire transfers, ATM, rewards programs, loyalty programs), travel credentials (e.g., boarding pass, visa, passport), medical credentials (e.g., medical history, prescriptions, primary care physician, allergies), identification credentials (e.g., corporate, government, education), insurance credentials (e.g., health, auto, liability) or any combination thereof. One of ordinary skill in the art would appreciate that there are numerous types of credentials that could be utilized with embodiments of the present invention, and embodiments of the present invention are contemplated for use with any type of credential.

According to an embodiment of the present invention, the wallet module may be configured to identify the specific type of transaction being requested (e.g., via transaction information provided by a POS terminal, third-party system, the finger vein analysis module, or any combination thereof). In this manner, the wallet module may retrieve only those credentials required to complete the transaction (e.g., only financial credentials for a purchase at a retail store). In situations where more than one appropriate credential may be available, the system may be configured to allow a user or consumer to select which credential they wish to use. For instance, a consumer may have multiple methods for paying for a purchase at a retail store; upon authorization, the consumer's mobile device may be alerted and allowed to select one or more payment means to complete the transaction. In this manner, only those credentials associated with the specific transaction type are ever exposed, protecting the consumer and user from any fraudulent usage of non-relevant credentials.

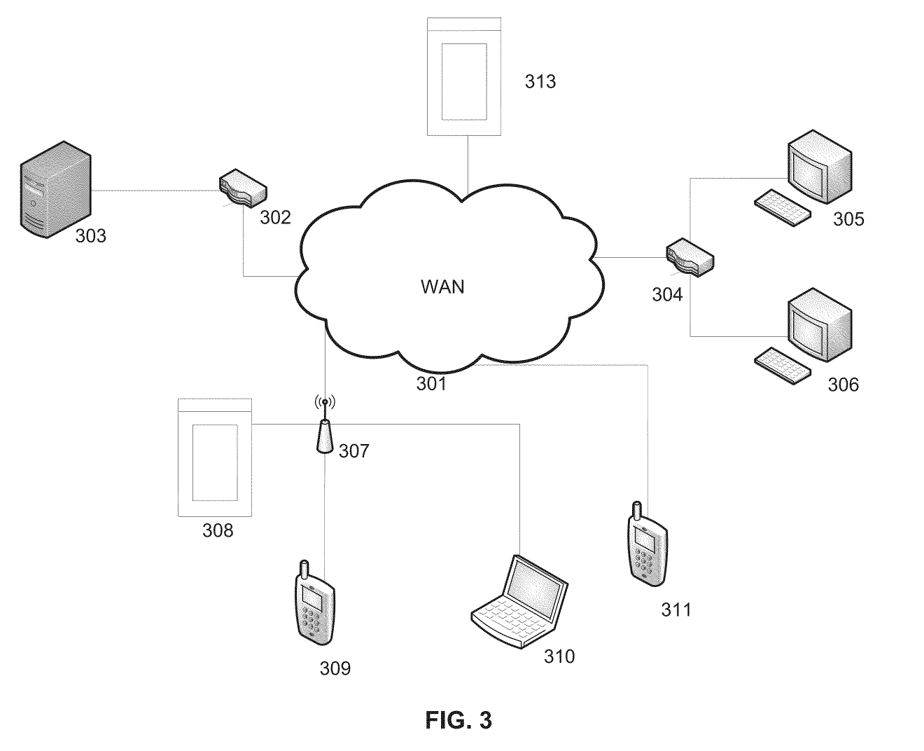

Turning now to FIG. 3, a schematic overview of a networked system in accordance with an embodiment of the present invention is shown. The system is comprised of one or more application servers 303 for electronically storing and processing information used by the system. Applications in the server 303 may retrieve and manipulate information in storage devices and exchange information through a WAN 301 (e.g., the Internet). Applications in server 303 may also be used to manipulate information stored remotely and process and analyze data stored remotely across a WAN 301 (e.g., the Internet).

According to an exemplary embodiment, as shown in FIG. 3, exchange of information through the WAN 301 or other network may occur through one or more high speed connections. In some cases, high speed connections may be over-the-air (OTA), passed through networked systems, directly connected to one or more WANs 301 or directed through one or more routers 302. Router(s) 302 are completely optional and other embodiments in accordance with the present invention may or may not utilize one or more routers 302. One of ordinary skill in the art would appreciate that there are numerous ways server 303 may connect to WAN 301 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 303 via WAN 301 or other network in numerous ways. For instance, a component may connect to the system i) through a POS terminal 313 directly connected to the WAN 301, ii) through a computing device 305, 306 connected to the WAN 301 through a routing device 304, iii) through a POS terminal 308, mobile computing device 309, or portable computing device 310 connected to a wireless access point 307 or iv) through a POS terminal or computing device 311 via a wireless connection (e.g., CDMA, GMS, 3G, 4G) to the WAN 301. One of ordinary skill in the art would appreciate that there are numerous ways that a component may connect to server 303 via WAN 301 or other network, and embodiments of the present invention are contemplated for use with any method for connecting to server 303 via WAN 301 or other network. Furthermore, application server 303 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

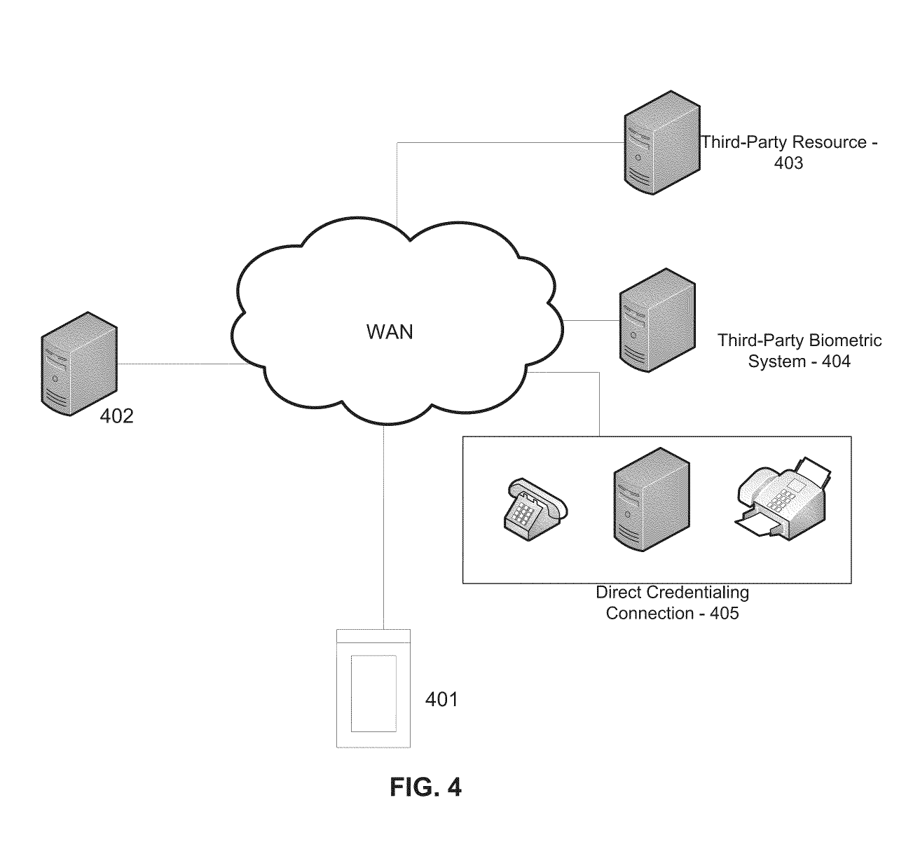

Turning now to FIG. 4, an expanded network schematic of a system in accordance with an embodiment of the present invention is shown. In FIG. 4, the system is shown as it may interact with users and other third party networks or APIs. For instance, a user of a POS terminal 401 utilizing a finger vein authentication means may be able to connect to application server 402 for additional processing of the finger vein authentication data. Application server 402 may be able to further enhance or otherwise provide additional services to the user by requesting, sending and receiving information from one or more of a third-party resource 403 (e.g., institutional finger vein authentication storage center), a third party biometric system 404 (e.g., private biometric information store or security company), one or more direct credentialing connections 405 (e.g., finger vein authentication storage associated with or affiliated with provider of the system, such as a chain retail store), or any combination thereof. For instance, in certain embodiments of the present invention, the system may utilize a connection to a third-party resource 403 via an API in order to confirm finger vein patterns scanned at the POS terminal 401 which provided the information to a centralized application server 402 which handles communication between the POS terminal 401 and the third-party resource 403. One of ordinary skill in the art would appreciate how accessing one or more third-party systems could augment the ability of the system described herein, and embodiments of the present invention are contemplated for use with any third-party system.

According to an embodiment of the present invention, the system may be augmented through utilization of a consumer application engaged on a computing device of the consumer and a merchant application engaged on a computing device of the merchant. In certain embodiments, both merchant and consumer applications and computing devices must have the app to perform the authentication methods described herein. Certain embodiments may further require hardware from both consumer computing device and merchant computing device (or any single computing device selected therefrom) to complete the transaction. In this embodiment one or more of the devices must have the ability to perform functionality related to the finger vein authentication means (e.g., infrared capable). The device(s) can be equipped with an integrated finger vein authentication means or augmented via an attachment capable of reading finger vein patterns.

According to an exemplary embodiment, one advantage of the methods described herein is that they help to solve a problem (disadvantage) with the process of vein pattern recognition with the temperature of the finger. With mid-air swipe, there is no contact with the actual finger, but it is infrared detection, so this reduces or completely eliminates issues related to finger temperature as the finger has no physical contact with a physical medium.

### Exemplary Embodiment

According to an exemplary embodiment, an authentication processes may be comprised of a two-step process for access and authorization. In this embodiment, a user will first perform an air swipe of one or more designated fingertips, by swiping the finger(s) in mid-air over or in the vicinity of an infrared signal at a POS terminal or other computing device (e.g., legacy POS terminals with infrared capability, mobile smart devices with infrared capability). Second, once the user has been authenticated, the user has access to the electronic wallet and can authorize or complete the transaction. To do this, the user will then perform an air stroke signature with the same designated fingertip(s) as was done during the air swipe. This is done by stroking the signature in mid-air in the path of the infrared signal. While this is being done, the system will also simultaneously check for consistency in finger vein pattern against the vein pattern approved for access. It is possible for a user to gain access and not be authorized for transaction, because, during the air stroke, the vein pattern is verified for consistency simultaneously while the signature is being verified. Advantageously, authentication is occurring at more than one point, further enhancing the overall security of the system. In this manner, it is possible for a user to successfully complete an air swipe authentication and gain access, but it's literally impossible for a transaction to be authorized without a successful air stroke signature with concurrent vein pattern authentication. Since the finger vein of each finger is unique, each individual finger on each individual hand can be used to control one or more specific credentials within a given electronic wallet.

In the aforementioned embodiment, whatever finger is used to access a credential (air swipe) then that same finger must be used to authorize the function within that credential (air stroke). For example, if a user uses a right index finger to access a financial credential, then the user will be required to use that same finger to authorize a transaction with the financial credential, such as a payment, by stroking a contactless signature.

Additional advantages of a contactless finger vein authentication method concept include, but are not limited to: (i) finger vein patterns are unique to an individual and does not change overtime; (ii) a finger vein pattern is unique on each finger, so a finger vein pattern contained on each individual finger (or multiple fingers in conjunction) can be used for a different function; (iii) a finger vein pattern is difficult to reproduce because it is underneath the skin; and (iv) a finger vein pattern is of no good if it is not attached to the living hand of an individual (e.g., dismembered hand/finger), unlike a fingerprint.

Additional advantages of a contactless finger vein authentication and signature method combination include, but are not limited to: (i) reduced chance for signature duplication because the signature is not readily displayed at POS; (ii) reduced chances for forgery, fraud, identity theft, impersonation, and signature replication, because the vein pattern is unique to each person and checked against the finger vein pattern used during authorization to ensure it is the same finger vein pattern that the signature is being made with, which was used for access; (iii) increases the speed of transactions and makes transactions seamless because the finger is readily available and is always with the user and the credentials are preset, so there is no flipping through a wallet for a payment method of choice or having to select which payment method you would like to use at POS; (iv) preset credentials are contained in specific and dedicated “pockets” (e.g., organized means associated with an electronic wallet) and therefore limits exposure and liability.

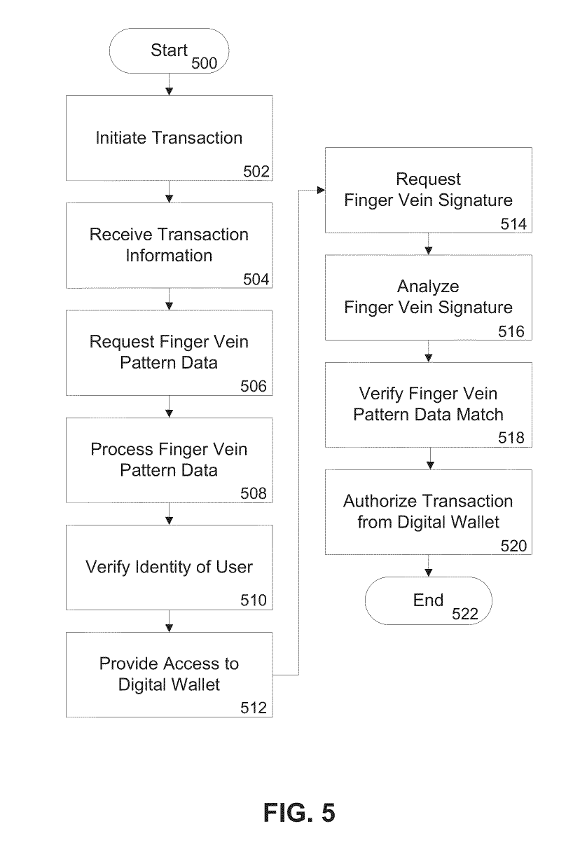

Turning now to FIG. 5, an exemplary embodiment of a method for utilization of the system and method as described herein is shown. At step 500, the process starts with a user preparing to complete a potential transaction. The user submits the potential transaction to the system for review and processing. Potential transactions may be initiated in any number of ways, such as entry from a POS terminal, via scanning/detection of a transaction related item (e.g., barcode, QR code), entry of a code or other identified (e.g., invoice number, transaction number) or through a computing device. One of ordinary skill in the art would appreciate that there are numerous types of means for initiating a potential transaction and embodiments of the present invention are contemplated for use with any means for initiating a potential transaction.

At step 502, the transaction is initiated within the system and the system begins to analyze the type of transaction and other information related to the transaction. At step 504, the system then retrieves relevant transaction information, such as transaction purpose (e.g., POS, purchase, identification, travel, insurance), transaction location, system information (e.g., local system, connectivity with remote system if required), or any combination thereof. One of ordinary skill in the art would appreciate there are numerous types of transaction information that could be utilized, and embodiments of the present invention are contemplated for use with any type of transaction information.

At step 506, the system requests and receives finger vein pattern data (e.g., via the finger vein detection means). Once the system receives the finger vein pattern data, the system processes the finger vein patter data at step 508. This can be done either locally or remotely as described and detailed herein.

At step 510, the finger vein pattern data is verified, as the finger vein pattern data is analyzed and compared to reference finger vein pattern data. Upon verifying the finger vein pattern data, the user is provided with access to the digital wallet at step 512.

At step 514, the system requests and receives from the user a finger vein signature as described and detailed herein. At step 516, the system will then process and analyze the finger vein signature, which is comprised of a signature stroke pattern and additional finger vein pattern data.

At step 518, the system verifies the finger vein signature. In a preferred embodiment, the system authenticates the finger stroke pattern and verifies that the finger vein pattern data of the finger(s) used to execute the finger stroke pattern matches the finger vein pattern data of the finger(s) used to access the digital wallet. Upon verifying the finger vein signature, the system authorizes a transaction from the digital wallet at step 520.

Once the transaction has been authorized, the process terminates at step 522.

If the user has been appropriately authenticated via the finger vein processing step, and, as optionally provided for in certain embodiments, provided and the system confirmed the signature of the user, the system confirms the transaction. In certain embodiments, this may also require the user or consumer to select one or more appropriate credentials from an electronic wallet as described and detailed herein. Data related to the completed transaction may be stored, including information related to the confirmation and analysis of the user's finger vein authentication and signature. Storage of such information may be done locally, such as at a POS terminal, or remotely at one or more remote computing devices.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing access to and authorization of electronic wallet transactions using finger vein analysis, said system comprising:
a vein analysis module, comprising computer-executable code stored in non-volatile memory,
a wallet module, comprising computer-executable code stored in non-volatile memory,
a processor, and
a vein detection means,
wherein said vein analysis module, said wallet module, said processor, and said vein detection means are operably connected and are configured to:
receive a transaction request;
initiate a transaction, wherein said transaction is analyzed to determine a transaction type;
retrieve transaction information, wherein said transaction information is comprised of one or more of a transaction purpose, a transaction location, and system information;
request finger vein authentication from user, wherein said finger vein detection means scans one or more of fingers of said user to generate a first finger vein pattern;
process said first finger vein pattern, wherein said first finger vein pattern is analyzed to authenticate identity of said user;
verify said identity of said user by comparing said first finger vein pattern to a reference finger vein pattern; and
provide access to one or more credentials stored in an electronic wallet.

2. The system of claim 1, wherein said vein analysis module, said wallet module, said processor, and said vein detection means are operably connected and are further configured to:
select one of said one or more credentials stored in said electronic wallet based on said transaction type.

3. The system of claim 1, wherein said vein analysis module, said wallet module, said processor, and said vein detection means are operably connected and are further configured to:
request a finger vein signature from said user, wherein said finger vein signature is collected with said finger vein detection means and comprised of a signature stroke pattern and a second finger vein pattern;
receive said finger vein signature from said user;
analyze said finger vein signature, wherein said signature stroke pattern is authenticated and said second finger vein pattern is compared to said first finger pattern;
verify that said second finger vein pattern matches said first finger vein pattern used to access said digital wallet; and
authorize a transaction to be completed from said digital wallet.

4. The system of claim 3, wherein said vein analysis module, said wallet module, said processor, and said vein detection means are operably connected and are further configured to store a transaction authorization comprised of an analysis of said finger vein signature.

5. The system of claim 1, wherein said finger vein detection means is configured to scan said one or more of fingers of said user without directly contacting said user.

6. The system of claim 1, further comprising one or more communication means operably connected to said vein analysis module, said wallet module, said processor, and said vein detection means.

7. The system of claim 6, wherein said finger vein data pattern is analyzed remotely using one or more remote computing devices communicatively linked to said finger vein analysis module.

8. The system of claim 1, wherein said finger vein data pattern is analyzed locally with said finger vein analysis module.

9. The system of claim 1, wherein said one or more credentials are selected from a group of credentials comprising financial credentials, travel credentials, medical credentials, identification credentials, and insurance credential.

10. A method for providing access to and authorization of electronic wallet transactions using finger vein analysis, said method comprising the steps of:
receiving a transaction request;
initiating a transaction, wherein said transaction is analyzed to determine a transaction type;
retrieving transaction information, wherein said transaction information is comprised of one or more of a transaction purpose, a transaction location, and system information;
requesting finger vein authentication from user, wherein one or more of fingers of said user are scanned to generate a first finger vein pattern;
processing said first finger vein pattern, wherein said first finger vein pattern is analyzed to authenticate identity of said user;
verifying said identity of said user by comparing said first finger vein pattern to a reference finger vein pattern; and
providing access to one or more credentials stored in an electronic wallet.

11. The method of claim 10, further comprising the step of selecting one of said one or more credentials stored in said electronic wallet based on said transaction type.

12. The method of claim 10, further comprising the steps of:
requesting a finger vein signature from said user, wherein said finger vein signature is collected with said finger vein detection means and comprised of a signature stroke pattern and a second finger vein pattern;
receiving said finger vein signature from said user;
analyzing said finger vein signature, wherein said signature stroke pattern is authenticated and said second finger vein pattern is compared to said first finger pattern;
verifying that said second finger vein pattern matches said first finger vein pattern used to access said digital wallet; and
authorizing a transaction to be completed from said digital wallet.

13. The method of claim 12, further comprising the step of storing a transaction authorization comprised of an analysis of said finger vein signature

14. The method of claim 10, wherein said finger vein data pattern is analyzed remotely using one or more remote computing devices communicatively linked to said finger vein analysis module.

15. The method of claim 10, wherein said finger vein data pattern is analyzed locally with said finger vein analysis module.

16. The method of claim 10, wherein said one or more credentials are selected from a group of credentials comprising financial credentials, travel credentials, medical credentials, identification credentials, and insurance credential.
